(19) United States
(12) Patent Application Publication
(10) Pub. No.: US 2026/0065276 A1
(43) Pub. Date: Mar. 5, 2026

(54) SYSTEM AND METHOD FOR SHARING KNOW YOUR CUSTOMER (KYC) DATA USING A BLOCKCHAIN

(71) Applicant: JPMorgan Chase Bank, N.A., New York, NY (US)

(72) Inventors: Sandeep KESWANI, Bangalore (IN); Mitul MEHTA, Mumbai (IN); Srinivasan KRISHNAN, Bangalore (IN); Rohit RAJ, Bangalore (IN); Ankur SAMBHAR, Bangalore (IN); Suresh SHETTY, Bengaluru (IN)

(73) Assignee: JPMorgan Chase Bank, N.A., New York, NY (US)

(21) Appl. No.: 18/920,165

(22) Filed: Oct. 18, 2024

(30) Foreign Application Priority Data
Sep. 5, 2024 (IN) 202411067263

(51) Int. Cl. G06Q 20/40; G06Q 20/38

(52) U.S. Cl. CPC G06Q 20/4014; G06Q 20/3829; G06Q 20/389; G06Q 2220/00

(57) ABSTRACT

A system and method for sharing know your customer (KYC) data using a blockchain are disclosed. The method includes receiving a first request from a user to access at least one service and obtaining user identity details. Next, the method includes registering at least one KYC data for the user. Next, the method includes storing the at least one KYC data into at least one database associated with the first institution. Next, the method includes loading the KYC data onto a distributed ledger through a smart contract, the KYC data is accessible with a private key associated with the KYC data. Next, the method includes receiving a second request to access the KYC data, from a second institution. Next, the method includes providing access to the KYC data to the second institution based on an execution of the smart contract using a successful verification of the private key.

### CROSS-REFERENCE TO RELATED APPLICATIONS

This application claims priority benefit from Indian Application No. 202411067263, filed on Sep. 5, 2024 in the India Patent Office, which is hereby incorporated by reference in its entirety.

### FIELD OF THE DISCLOSURE

This technology generally relates to data processing and sharing, and more particularly relates to methods and systems for sharing know your customer (KYC) data using a blockchain.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

The rapid advancement of computing technologies has enabled Internet technology to spread into various sectors such as the entertainment sector and financial sector. In the banking and financial sector, numerous types of banking and finance related services (such as third-party payment, online banking, and purchase of products) are offered to consumers or customers over the Internet.

However, to avail banking and finance related services, customers are first required to undergo a know-your-customer (KYC) process. The KYC is a process of verifying the identity, eligibility, and background verification of a customer for establishing a business relationship. The main objective of the KYC is to prevent banks from being used for money laundering, fraudulent, and other criminal activities.

Currently, the KYC process is manually performed by agents or bank officials. Manual KYC processes are prone to bias, errors, and inconsistencies, as the bank officials may overlook important details or make errors during the data entry and verification process. These errors may lead to compliance issues, regulatory fines, and reputational damage to the financial institutions. Hence, the current KYC system followed by financial institutions (such as banks) is slow, tedious, and has lots of redundancies since the customer has to complete the KYC process multiple times separately with different banks or different lines of business. Also, the current KYC system fails to maintain the privacy of the identity of the customer due to the handling of physical documents at multiple points within the bank or different banks. Thus, the KYC system currently fails to provide secure sharing of KYC data with multiple banks.

Hence, in view of these and other existing limitations, there arises an imperative need to provide an efficient solution to overcome the above-mentioned limitations and to provide a method and system for efficiently and sharing KYC data in secured way with financial institutions.

### SUMMARY

The present disclosure, through one or more of its various aspects, embodiments, and/or specific features or sub-components, provides, inter alias, various systems, servers, devices, methods, media, programs, and platforms for sharing know your customer (KYC) data using a blockchain.

According to an aspect of the present disclosure, a method for sharing know your customer (KYC) data using a blockchain is disclosed. The method is implemented by at least one processor. The method includes receiving, by the at least one processor, a first request from a user to access at least one service of a first institution. Next, the method includes obtaining, by the at least one processor, user identity details from the user in response to the first request. Next, the method includes registering, by the at least one processor, at least one KYC data for the user upon a successful verification of the user identity details. Next, the method includes storing, by the at least one processor, the at least one KYC data into at least one database associated with the first institution. Next, the method includes loading, by the at least one processor, the at least one KYC data onto a distributed ledger through a smart contract, wherein the at least one KYC data is accessible with a private key associated with the at least one KYC data. Next, the method includes receiving, by the at least one processor, a second request to access the at least one KYC data of the user on the distributed ledger, from a second institution. Next, the method includes providing, by the at least one processor, access to the at least one KYC data to the second institution based on an execution of the smart contract using a successful verification of the private key.

In accordance with an exemplary embodiment, the user identity details include personal identity details, contact details, income details, and transaction details.

In accordance with an exemplary embodiment, the at least one KYC data includes verified documents corresponding to the user identity details.

In accordance with an exemplary embodiment, the smart contract includes at least one from among a block identifier, a transaction identifier, a chain identifier a contract address, and business logic parameters.

In accordance with an exemplary embodiment, the smart contract is encrypted using encryption techniques to avoid an unauthorized access to the at least one KYC data.

In accordance with an exemplary embodiment, upon successful completion of a blockchain consensus process, the at least one KYC data is loaded onto the distributed ledger.

In accordance with an exemplary embodiment, the successful completion of the blockchain consensus process includes validating, by the at least one processor, the smart contract by executing the blockchain consensus process involving a plurality of trusted parties associated with a blockchain network.

In accordance with an exemplary embodiment, the method includes updating, by the at least one processor, the at least one KYC data upon receipt of a data updating request from the second institution.

According to another aspect of the present disclosure, a computing device configured to implement an execution of a method for sharing know your customer (KYC) data using a blockchain is disclosed. The computing device includes a processor; a memory; and a communication interface coupled to each of the processor and the memory. The processor may be configured to receive a first request from a user to access at least one service of a first institution. Next, the processor may be configured to obtain user identity details from the user in response to the first request. Next, the processor may be configured to register at least one KYC data for the user upon completion of a successful verification of the user identity details. Next, the processor may be configured to store the at least one KYC data into at least one database associated with the first institution. Next, the processor may be configured to load the at least one KYC data onto a distributed ledger through a smart contract, wherein the at least one KYC data is accessible with a private key associated with the at least one KYC data. Next, the processor may be configured to receive a second request to access the at least one KYC data of the user on the distributed ledger, from a second institution. Next, the processor may be configured to provide access to the at least one KYC data to the second institution based on an execution of the smart contract using a successful verification of the private key.

In accordance with an exemplary embodiment, the user identity details include personal identity details, contact details, income details, and transaction details.

In accordance with an exemplary embodiment, the at least one KYC data includes verified documents corresponding to the user identity details.

In accordance with an exemplary embodiment, the smart contract includes at least one from among a block identifier, a transaction identifier, a chain identifier, a contract address, and business logic parameters.

In accordance with an exemplary embodiment, the smart contract is encrypted using encryption techniques to avoid an unauthorized access to the at least one KYC data.

In accordance with an exemplary embodiment, upon successful completion of a blockchain consensus process, the at least one KYC data is loaded onto the distributed ledger.

In accordance with an exemplary embodiment, for the successful completion of the blockchain consensus process, the processor may be configured to validate the smart contract through execution the blockchain consensus process involving a plurality of trusted parties associated with a blockchain network.

In accordance with an exemplary embodiment, the processor may be configured to update the at least one KYC data upon reception of a data updating request from the second institution.

According to yet another aspect of the present disclosure, a non-transitory computer-readable storage medium storing instructions for sharing know your customer (KYC) data using a blockchain is disclosed. The instructions include executable code which, when executed by a processor, may cause the processor to receive a first request from a user to access at least one service of a first institution; obtain user identity details from the user in response to the first request; register at least one KYC data for the user upon completion of a successful verification of the user identity details; store the at least one KYC data into at least one database associated with the first institution; load the at least one KYC data onto a distributed ledger through a smart contract, wherein the at least one KYC data is accessible with a private key associated with the at least one KYC data; receive a second request to access the at least one KYC data of the user on the distributed ledger, from a second institution; and provide access to the at least one KYC data to the second institution based on an execution of the smart contract using a successful verification of the private key.

In accordance with an exemplary embodiment, the user identity details include personal identity details, contact details, income details, and transaction details.

In accordance with an exemplary embodiment, the at least one KYC data includes verified documents corresponding to the user identity details.

In accordance with an exemplary embodiment, the smart contract includes at least one from among a block identifier, a transaction identifier, a chain identifier, a contract address, and business logic parameters.

In accordance with an exemplary embodiment, the smart contract is encrypted using encryption techniques to avoid an unauthorized access to the at least one KYC data.

In accordance with an exemplary embodiment, upon successful completion of a blockchain consensus process, the at least one KYC data is loaded onto the distributed ledger.

In accordance with an exemplary embodiment, for the successful completion of the blockchain consensus process, the executable code when executed causes the processor to validate the smart contract through execution of the blockchain consensus process involving a plurality of trusted parties associated with a blockchain network.

In accordance with an exemplary embodiment, the executable code when executed causes the processor to update the at least one KYC data upon reception of a data updating request from the second institution.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system for sharing know your customer (KYC) data using a blockchain, in accordance with an exemplary embodiment of the present disclosure.

FIG. 2 illustrates an exemplary diagram of a network environment for sharing know your customer (KYC) data using a blockchain, in accordance with an exemplary embodiment of the present disclosure.

FIG. 3 illustrates an exemplary system for sharing know your customer (KYC) data using a blockchain, in accordance with an exemplary embodiment of the present disclosure.

FIG. 4 illustrates an exemplary method flow diagram for sharing know your customer (KYC) data using a blockchain, in accordance with an exemplary embodiment of the present disclosure.

FIG. 5 illustrates a process flow diagram usable for sharing know your customer (KYC) data using a blockchain, in accordance with an exemplary embodiment of the present disclosure.

FIG. 6 illustrates an exemplary system flow diagram for sharing know your customer (KYC) data among two financial institutions using a blockchain, in accordance with an embodiment of the present disclosure.

FIG. 7 illustrates an exemplary blockchain architecture depicting the loading of KYC details onto a blockchain, in accordance with an embodiment of the present disclosure.

FIG. 8 illustrates an exemplary blockchain architecture depicting the process to access KYC details on a blockchain, in accordance with an embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skills in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Furthermore, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable mediums, having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

To overcome the above-mentioned problems, the present disclosure provides a method and system for sharing know your customer (KYC) data using a blockchain. More particularly, the present disclosure provides a solution for resolving problems associated with a current KYC system where customers have to go through an independent KYC process at different banks due to the unavailability of secure and decentralized KYC data sharing between banks. In the present disclosure, the system receives a first request from a user or customer to access at least one service of a first institution (e.g., a primary bank). In an example, the first request may be received to access financial-related services (e.g., account opening) at a bank. Further, the system obtains user identity details from the user in response to the first request to verify and authenticate the identity of the user. The system further registers at least one KYC data for the user and stores the at least one KYC data in at least one database associated with the first institution. The system further loads the at least one KYC data onto a distributed ledger through a smart contract, the at least one KYC data is accessible with a private key associated with the at least one KYC data. The further receives a second request to access the at least one KYC data of the user on the distributed ledger, from a second institution. Finally, the system provides access to the at least one KYC data to the second institution based on an execution of the smart contract using a successful verification of the private key. This way the system allows sharing of KYC data using a blockchain.

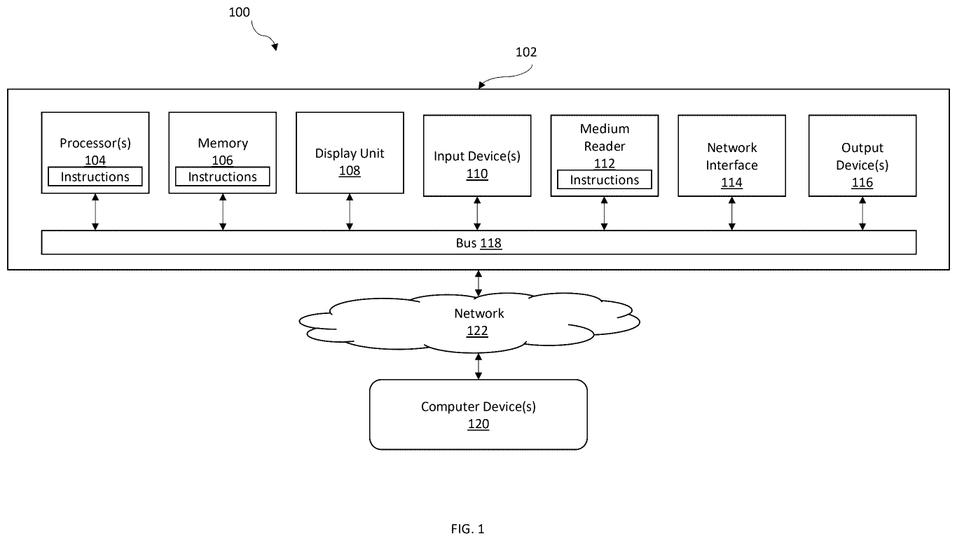

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environment. Even further, the instructions may be operative in such a cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), synchronous dynamic random access memory (SDRAM), double data read (DDR) memory, read-only memory (ROM), flash memory, electrically programmable read-only memory (EPROM), electrically erasable programmable read-only memory (EEPROM), registers, a hard disk, a cache, a removable, disk, tape, compact disk read-only memory (CD-ROM), digital versatile disk (DVD), floppy disk, Blu-ray disk, or any other form of storage medium known in the art. Memories may be volatile or non-volatile, secure and/or encrypted, and unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, liquid retina extreme dynamic range (XDR), mini light emitting diode (LED), or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for sharing know your customer (KYC) data using a blockchain.

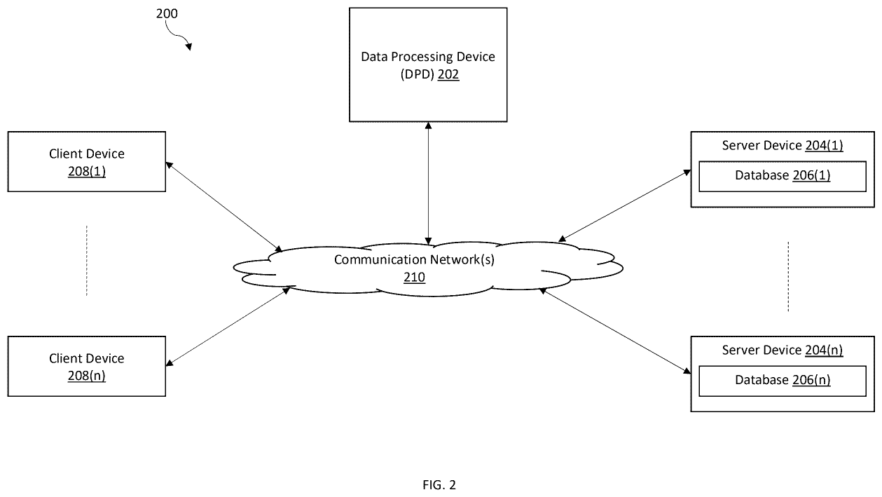

Referring to FIG. 2, a schematic of an exemplary network environment 200 for implementing a method for sharing know your customer (KYC) data using a blockchain is illustrated. In an exemplary implementation, the method is executable on any networked computer platform, such as, for example, a personal computer (PC).

The method for sharing know your customer (KYC) data using a blockchain may be implemented by a data processing device (DPD) 202. The DPD 202 may be the same or similar to the computer system 102 as described with respect to FIG. 1. The DPD 202 may store one or more applications that can include executable instructions that, when executed by the DPD 202, cause the DPD 202 to perform desired actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the DPD 202 itself, may be located in the virtual server(s) running in a cloud-based computing environment rather than being tied to one or more specific physical network computing devices. Also, the application(s) may be running in one or more virtual machines (VMs) executing on the DPD 202. Additionally, in one or more embodiments of this technology, virtual machine(s) running on the DPD 202 may be managed or supervised by a hypervisor.

In the network environment 200 of FIG. 2, the DPD 202 is coupled to a plurality of server devices 204(1)-204(n) that hosts a plurality of databases 206(1)-206(n), and also to a plurality of client devices 208(1)-208(n) via communication network(s) 210. A communication interface of the DPD 202, such as the network interface 114 of the computer system 102 of FIG. 1, operatively couples and communicates between the DPD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DPD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and DPDs that efficiently implement the method for sharing know your customer (KYC) data using a blockchain.

By way of example only, the communication network(s) 210 may include local area network(s) (LAN(s)) or wide area network(s) (WAN(s)), and may use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The DPD 202 may be a standalone device or integrated with one or more other devices or apparatuses, such as one or more of the server devices 204(1)-204(n), for example. In one particular example, the DPD 202 may include or be hosted by one of the server devices 204(1)-204(n), and other arrangements are also possible. Moreover, one or more of the devices of the DPD 202 may be in the same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the DPD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data required for implementation of the features of the present disclosure. For instance, data related to know your customer (KYC) details of the user.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the DPD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary implementation, at least one client device 208 is a wireless mobile communication device, e.g., a smartphone.

The client devices 208(1)-208(n) may run interface applications, such as standard web browsers or standalone client applications, which may provide an interface to communicate with the DPD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the DPD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the DPD 202, the server devices 204(1)-204(n), or the client devices 208(1)-208(n), for example, may be configured to operate as virtual instances on the same physical machine. In other words, one or more of the DPD 202, the server devices 204(1)-204(n), or the client devices 208(1)-208(n) may operate on the same physical device rather than as separate devices communicating through communication network(s) 210. Additionally, there may be more or fewer DPDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, may also be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

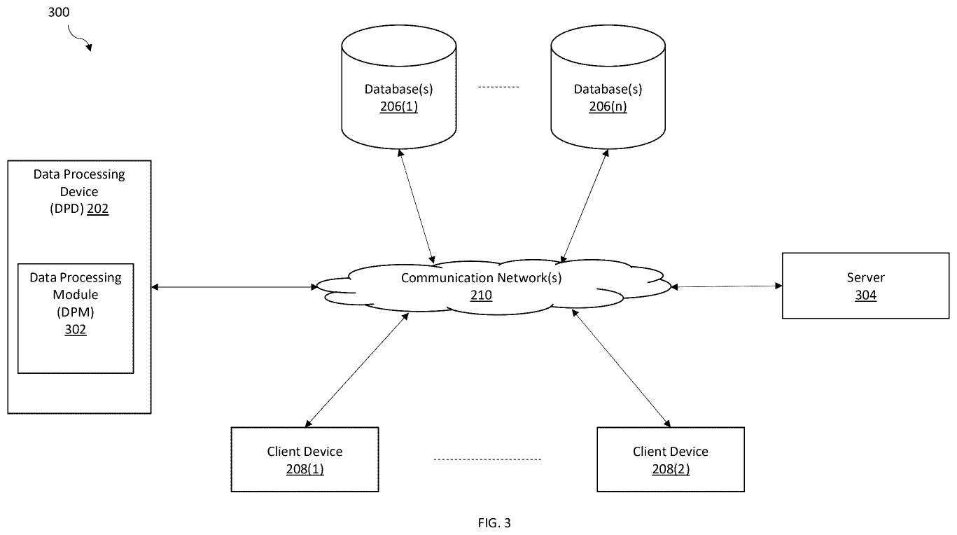

FIG. 3 illustrates a system diagram for implementing a method for sharing know your customer (KYC) data using a blockchain, in accordance with an exemplary embodiment.

As illustrated in FIG. 3, the system 300 may include an DPD 202 within which a data processing module (DPM) 302 is embedded, a server 304, a database(s) 206(1). . .206(n), a plurality of client devices 208(1) . . . 208(2), and a communication network(s) 210.

According to exemplary embodiments, the DPD 202 including the DPM 302 may be connected to the server 304, and the database(s) 206(1) . . . 206(n) via the communication network(s) 210, but the disclosure is not limited thereto. The DPD 202 may also be connected to the plurality of client devices 208(1) . . . 208(2) via the communication network 210, but the disclosure is not limited thereto. The database(s) 206(1) . . . 206(n) may include rule database.

In an embodiment, the DPD 202 is described and shown in FIG. 3 as including the DPM 302, although it may include other rules, policies, modules, databases, or applications, for example. As will be described below, the DPM 302 is configured to implement a method for sharing know your customer (KYC) data using a blockchain.

An exemplary system 300 for implementing a mechanism for sharing know your customer (KYC) data using a blockchain by utilizing the network environment of FIG. 2 is shown as being executed in FIG. 3. Specifically, a first client device 208(1) and a second client device 208(2) are illustrated as being in communication with the DPD 202. In this regard, the first client device 208(1) and the second client device 208(2) may be “clients” of the DPD 202 and are described herein as such. Nevertheless, it is to be known and understood that the first client device 208(1) and/or the second client device 208(2) need not necessarily be “clients” of the DPD 202, or any entity described in association therewith herein. Any additional or alternative relationship may exist between either or both of the first client device 208(1) and the second client device 208(2) and the DPD 202, or no relationship may exist.

Further, the DPD 202 is illustrated as being able to access one or more databases 206(1) . . . 206(n). The DPM 302 may be configured to access these repositories/databases for implementing a method for sharing know your customer (KYC) data using a blockchain. In some embodiment, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the DPD 202 via broadband or cellular communication. These embodiments are merely exemplary and are not limiting or exhaustive.

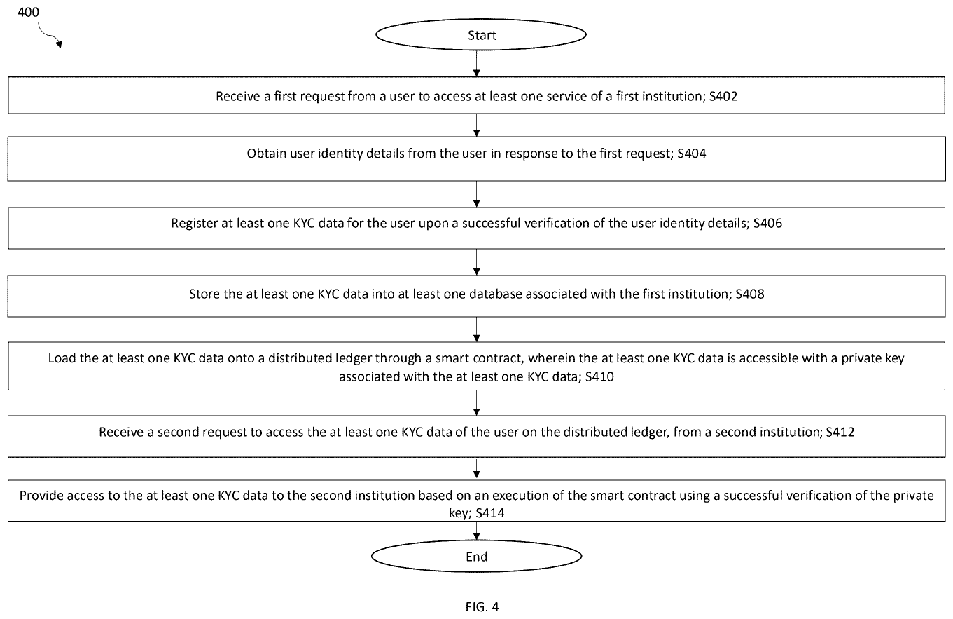

Referring to FIG. 4, an exemplary method 400 is shown for sharing know your customer (KYC) data using a blockchain, in accordance with an exemplary embodiment.

As shown in FIG. 4, the method 400 begins following a need for sharing identity data of customers (such as KYC data) among multiple financial institutions (such as banks) to avoid repetitive KYC processes of the customers. The method 400 is implemented by at least one processor 104.

The term “identity data” herein may correspond to the information collected by financial institutions to verify the identity of their customers. The identity data may include personally identifiable information such as name, date of birth, address, government-issued identity documents (like passport or driver's license), and sometimes biometric data. As used herein, identity refers to the unique characteristics and attributes associated with an individual that distinguish them individual from other individuals.

At step S402, the method 400 includes receiving, by the at least one processor 104, a first request from a user to access at least one service of a first institution.

The term “service” herein may correspond to the various financial products (such as account opening, deposit accounts, loans, credit cards, and investment services) offered by banks to their customers.

The term “products” herein may correspond to banking products that are an essential part of the financial ecosystem, providing individuals and businesses with a wide range of services to manage and invest their money.

The term “KYC” herein may correspond to a process of collecting and verifying information such as address, contact details, biometric details, and identity details of a user or customer by financial institutions.

For example, if an account of the user (or hereinafter also referred to as a customer) is associated with a financial institution (such as a bank) and the user needs to avail some service provided by the financial institution then the user has to raise the first request for a particular service. For example, the at least one processor 104 may receive the first request to access the at least one service of the financial institution from the user over a user platform (e.g., application or website) that may be associated with the financial institution such as a bank. For example, a bank may require a customer or user to undergo a KYC process when the user requests to open a new account or access a new banking service.

At step S404, the method includes obtaining, by the at least one processor 104, user identity details from the user in response to the first request.

The user identity details include but are not limited to, personal identity details (such as name, address, and contact information), contact details (mobile number and e-mail address), income details (such as income, employment status, assets, and debts), and transaction details (such as transaction history and bank statements). In an exemplary implementation, the user identity details may include biometric details (such as facial images, fingerprints, iris scans, etc.).

In an exemplary implementation, the method for obtaining the user identity details may include scanning and processing electronic documents received from a user device via the user platform. In another exemplary implementation, the method for obtaining the user identity details may include importing the user identity details from external monetary management software or platforms the user might be using.

For example, a bank may require the customer to undergo the KYC process when opening a new account via the user platform. Further, the at least one processor 104 receives the first request from the customer or user to complete the KYC process to avail at least one service such as opening a new account. To complete the KYC process, the customer needs to provide their identity details such as identification documents, proof of address, and some additional information depending on the bank's requirements. The bank further verifies the user identity details and information provided by the customer to comply with regulations and ensure the customer's identity. Thus, the KYC process helps to establish trust between the bank and the customer and protect against financial crimes.

At step S406, the method includes registering, by the at least one processor 104, at least one KYC data for the user upon a successful verification of the user identity details.

The term “registration” herein may correspond to the collection, recording, and storage of the user personal information and identification documents.

The term “verification” herein may correspond to the process of confirming the identity of a user, customer or client using a data verification mechanism. In an example, the documents (such as the user identity card, and the user address proof) may be verified based on data available on third-party databases, servers, social platforms, and the like. In another example, the address of the user in the document may be verified using the user data available in an official record.

The at least one KYC data includes verified documents corresponding to the identity details (such as name, address, and contact information), contact details (mobile number and e-mail address), income details (such as income, employment status, assets, and debts), and biometric details (such as facial images, fingerprints, iris scans, etc.).

The method includes analyzing, by the at least one processor 104, the user identity details such as the personal identity details (such as name, address, and contact information), contact details, income details (such as income, employment status, assets, and debts), transaction details (such as transaction history and bank statements), and biometric details (such as facial images, fingerprints, iris scans, etc.).

At step S408, the method includes storing, by the at least one processor 104, the at least one KYC data into at least one database associated with the first institution.

The first institution may be a financial institution such as a first bank. The first institution acts as a primary bank for the user who raised the request for the at least one service. The at least one database may be connected with the at least one processor 104. The at least one database acts as a safe repository for storing the at least one KYC data of the user and may use the stored at least one KYC data for future reference.

For example, the bank may collect and record (via the user platform) the at least one KYC data in their database, ensuring that all necessary information is accurately captured and securely stored. The registration of the at least one KYC data helps the bank comply with regulatory requirements, verify the customer's identity, and assess the risk associated with the customer.

At step S410, the method includes loading, by the at least one processor 104 the at least one KYC data onto a distributed ledger through a smart contract. The at least one KYC data is accessible with a private key associated with the at least one KYC data.

The term “distributed ledger” herein may correspond to a decentralized database system that securely stores and shares customer identity information across multiple parties or organizations.

The term “smart contract” herein may correspond to a self-executing contract with the terms of the agreement directly written into lines of code on a blockchain or distributed ledger. Such a smart contract automatically executes and enforces the terms of the agreement when predefined conditions are met, without the need for intermediaries. The smart contract ensures transparency, security, and efficiency in transactions or data sharing on the blockchain or distrusted ledger.

The term “private key” herein may refer to a form of cryptography (such as a password or secret code) used for the distributed ledger that is used to sign transactions and prove ownership of digital assets or data available on the blockchain and prevent an unauthorized access to your funds. The private key acts as a Blockchain encryption scheme with which one party (e.g., prover) may prove to another party (verifier) that identity information may be trusted without revealing any details of identity information. For example, a prover needs to show a verifier the hashed value of their digital footprint stored in blockchain exchange, without showing the actual information. The verifier then compares the hashed value received from the prover to the hashed value stored on the blockchain (such as the distributed ledger). For example, each public key comes paired with a unique private key. The unique private key ensures that only authenticated users who have the private key can get access to the KYC data. In the case of encrypted messages, the private key is used to decrypt messages.

In an implementation, upon successful completion of a blockchain consensus process, the at least one KYC data is loaded onto the distributed ledger.

The term “blockchain consensus process” herein may correspond to a crucial mechanism that allows multiple nodes or trusted parties (e.g., authorized persons) or blockchain peers in a decentralized network to agree on the validity of transactions and maintain a consistent ledger of records. The blockchain consensus process ensures that all nodes or trusted parties or blockchain peers in the network reach an agreement on the order and validity of transactions without the need for a central authority.

The successful completion of the blockchain consensus process includes validating, by the at least one processor 104, the smart contract by executing the blockchain consensus process involving a plurality of trusted parties associated with a blockchain network or the distributed ledger. For example, the processor could be a node in the blockchain network, that processes and executes the instructions written in the smart contract. The plurality of trusted parties may include nodes or participants (such as banks or individuals) that collectively validate and confirm transactions through the blockchain consensus mechanism. The blockchain consensus mechanism may be selected from but is not limited to Istanbul byzantine fault tolerance (IBFT) and practical byzantine fault tolerance (PBFT).

The smart contract includes at least one from among a block identifier, a transaction identifier, a chain identifier, a contract address, and business logic parameters. As used herein, an identifier refers to a name, symbol, or unique sequence of characters used to distinguish one entity from another within a specific context. The block identifier typically refers to a unique identifier for a specific block in the blockchain. The block identifier helps in referencing or retrieving a particular block from a chain of blocks. The transaction identifier is a unique identifier assigned to each transaction within the blockchain, allowing for tracking and referencing specific transactions. The chain identifier is a unique identifier for the blockchain network itself, distinguishing it from other chains in the blockchain network.

The smart contract is encrypted using encryption techniques to avoid an unauthorized access to the at least one KYC data. In an exemplary implementation, the encryption techniques may include a private transaction manager (for example, Tessera®) and quorum. The private transaction manager facilitates encryption, decryption, and distribution of private transactions related to the smart contract(s). The quorum is a permission-based blockchain protocol built on the distributed ledger and operates as a private blockchain. Therefore, access to the distributed ledger is restricted to specific authorized participants, typically pre-approved organizations (such as financial institutions) or individuals within a consortium.

For example, KYC data records of the users or customers may be securely stored and shared with other banks using blockchain technology. Financial institutions (such as banks) may receive access to the KYC data records present on the blockchain upon successful execution of the smart contract to ensure that all relevant parties have access to up-to-date and accurate KYC-related information.

At step S412, the method includes receiving, by the at least one processor 104, a second request to access the at least one KYC data of the user on the distributed ledger, from a second institution (for example, a second bank or secondary bank). For example, once an original miner (such as a first institution) in the blockchain network ingests KYC payload (e.g., at least one KYC data) over the blockchain network, such KYC payload is mined as a block of transaction after a successful verification by other participants in the blockchain network. Thereafter, the KYC payload is available for other blockchain participants with restricted access/full access in the reactive mode after approval of the second request from the original miner.

The method includes receiving, by the at least one processor 104, the second request from the second institution (such as the secondary bank) to access the at least one KYC data of the user to provide a service (such as a new account opening) to the user. For example, a requestor node (e.g., the second institution) may place a request to obtain an encryption key for accessing the KYC data of a specific user that is mined by the miner. Once the request is approved by the miner (e.g., the first institution), the miner may share the requested information, such as the KYC data, with the requestor node privately using a Tessera® transaction manager.

For example, if a customer's bank account is associated with the primary bank and the customer goes to the secondary bank for banking needs such as a loan or a credit card, then the secondary bank triggers the second request to access at least one KYC data related to the customer to get information (such as the at least one KYC data) from the distributed ledger.

In an exemplary implementation, the method includes receiving, by the at least one processor 104, a positive response from the first institution to accept the second request in case of reception of user consent and successful execution of the smart contract. As used herein, the smart contract has multiple purposes such as during mining of the KYC information a set of rules needs to be executed to suffice the business requirement. Also, a different set of rules needs to be executed while searching for existing KYC information in the blockchain network by the second institution. The successful execution of the smart contract allows the second institution to access the existing KYC data of the user.

At step S414, the method includes providing, by the at least one processor 104, access to the at least one KYC data to the second institution based on an execution of the smart contract using a successful verification of the private key.

The method includes updating, by the at least one processor 104, the at least one KYC data upon receipt of a data updating request from the second institution.

Furthermore, the method includes executing, by the at least one processor 104, the smart contract upon successful matching of the hashed value of the private key with a hashed value stored on the distributed ledger or blockchain.

For example, the secondary bank may be able to fetch the at least one KYC data of the user from the distributed ledger and use that fetched KYC data for completing transactions related to a service provided by the secondary bank to the user. This way the disclosed method enables intra-bank data sharing of KYC data by maintaining privacy and avoiding issues (such as data misuse and data laps) associated with the manual data sharing process.

The method further includes receiving, by the at least one processor 104, a negative response from the first institution via the UI of the user platform to reject the second request for accessing the at least one KYC data. Failure in the execution of the smart contract denies access to the existing KYC data of the user to the second institution.

In an exemplary implementation, the method includes providing an override option over the UI of the user platform that allows another miner (e.g., the second institution) to override the existing KYC information of a user or client within the block chain network. To override the existing KYC information, further revalidation is required by different miners within the blockchain as per the blockchain consensus process. In the revalidation process, the original miner has more mandatory authority to approve and allow updates of KYC information on the same block as a new transaction being appended as a ledger of information. Thus, information related to updates in the KYC information is shared with all the miners or participants having access to the existing KYC information.

For example, the secondary bank further initiates a customer due diligence lifecycle with the fetched details (for example, at least one KYC data of the customer) and completes a case or transaction related to a service requested by the same customer that associated with the primary bank.

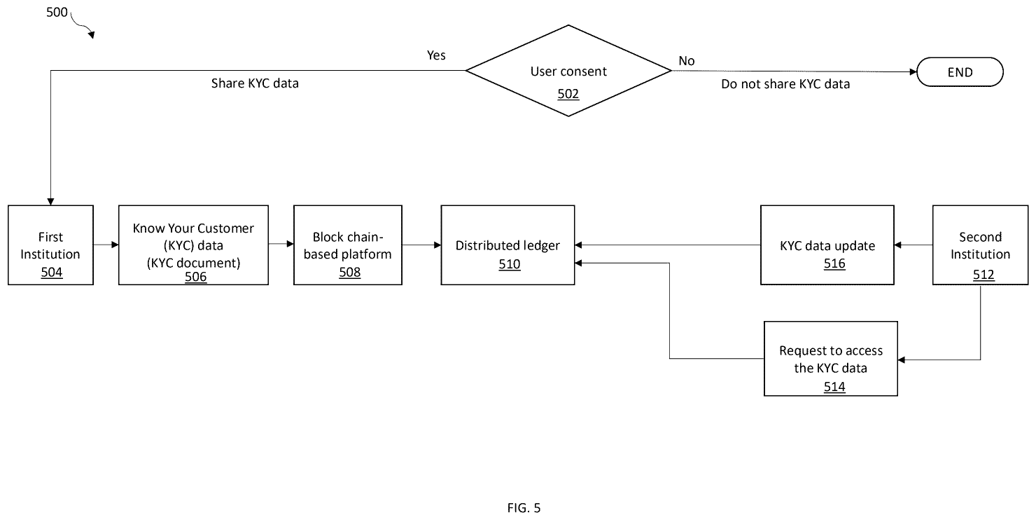

FIG. 5 illustrates a process flow diagram usable for sharing know your customer (KYC) data using a blockchain, in accordance with an exemplary embodiment. As illustrated in FIG. 5, the process flow 500 begins with receiving, by a first institution 504 over a user platform (e.g., application or website) installed in a system of the first institution 504, a user consent 502 from a user for sharing it's know your customer (KYC) details. The user consent is received upon reception of a first request of the user to access at least one service. Once the user provides consent 502 for sharing the KYC details, at least one processor 104 registers at least one KYC data 506 (for example, KYC data as shown in FIG. 5) based on the user identity details provided by the user using the user platform. Further, the at least one processor 104 uploads the at least one KYC data 506 to a disturbed ledger 510 (or also referred to as blockchain) via a blockchain-based platform 508. The blockchain-based platform is configured to support a plurality of blockchain services.

The at least one processor 104 may be a part of a server that utilizes quorum, which is a private blockchain protocol. The at least one processor 104 may upload the at least one KYC data 506 through a smart contract on the blockchain 510.

In an exemplary implementation, the blockchain 510 is a private blockchain consortium. The private blockchain consortium is a type of blockchain network that is operated and controlled by a group of pre-selected participants, typically organizations (e.g., banks) or entities with a shared interest or goal. Further, the method terminates or ends if the user does not provide consent to the first institution to upload or share the KYC data on the blockchain network.

Further, the at least one processor 104 may receive a second request 514 from a second institution 512 to access the loaded at least one KYC data 506 of the user onto the distributed ledger 510. For example, if a user bank account is associated with a primary bank and the user goes to a secondary bank for banking needs such as a loan, then the secondary bank may trigger the second request to access the smart contract with details of the users or client to get information from the distributed ledger 510. Furthermore, the at least one processor 104 provides access to the at least one KYC data 506 defined in the smart contract upon successful execution of the smart contract.

Further, the second institution 512 may raise a data updating request to update 516 the at least one KYC data 506 after the completion of at least one transaction for the user. In an exemplary implementation, an override option may be provided on a user interface (UI) of the user platform installed in a user device to allow the user to reject the second request corresponding to KYC update consent raised by the second institution 512.

The method further includes receiving, by the at least one processor 104, a negative response from various participants of the blockchain network to reject the second request 514 for accessing the at least one KYC data 506. Thus, the second institution may not be able to access the KYC data of the user.

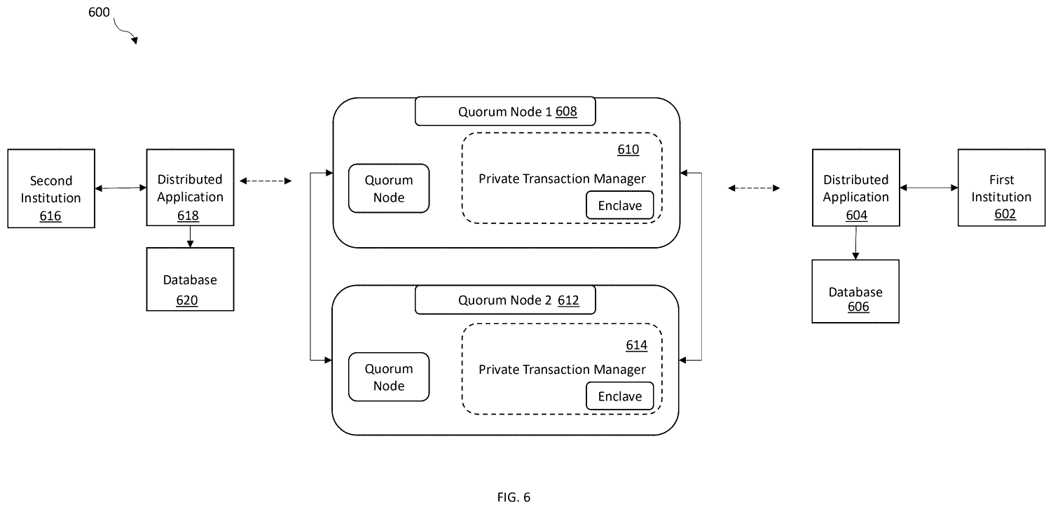

FIG. 6 illustrates an exemplary system flow diagram for sharing know your customer (KYC) data among two financial institutions using a blockchain, in accordance with an embodiment of the present disclosure. As illustrated in FIG. 6, the system flow 600 begins with receiving user identity details over a user interface (UI) (for example, banking product's user interface) of a user platform for authorizing and validating the user identity details. The user identity details may be further processed by internal departments (e.g., corporate and investment banking (CIB) front office) of a first institution (e.g., primary bank) 602 and stored in a local database or database 606 of the first institution 602. Further, at least one KYC data of the user is registered upon verification of the user identity details. Thereafter, the at least one KYC data is loaded into a distribution application (also referred to as DApp) 604 and further uploaded to the blockchain or distributed ledger using a smart contract. Further, the smart contract may be added into at least two quorum nodes referred to as quorum node 1 608 and quorum node 2 612 (on a Quorum network ledger) via a quorum. The two quorum nodes 608, 612 are provided by the Quorum network ledger which is a private blockchain protocol. The smart contract is encrypted using a private transaction manager (e.g., Tessera®) to maintain the privacy and security of the at least one KYC data 506.

When a second institution 616 requests for KYC details and triggers the smart contract with details of the user or client to get the at least one KYC data 506 of the user from the distributed ledger. In an exemplary implementation, documentary and KYC data of the user is to be exchanged by the first institution (e.g., primary bank) (where the customer is first associated) with a second institution (e.g., secondary bank) via the distributed ledger for executing a new transaction for the same customer.

Further, the private transaction managers 610 and 614 are configured in the at least two quorum nodes 608 and 612. The private transaction manager (such as Tessera®) executes the smart contract upon a successful verification of a private key in response to the second request raised by the second institution 616. The smart contract includes at least one from among a block identifier, a transaction identifier, a chain identifier, a contract address, and business logic parameters corresponding to the at least one KYC data.

Further, the at least two quorum nodes 608, 612 provide access to the at least one KYC data of the customer defined in the smart contract template to the second institution. The second institution 616 then initiates a customer due diligence lifecycle with the provided details (for example, at least one KYC data of the customer) and completes a case or transaction as requested by the customer that is associated with the first institution 602. At last, the secondary institution 616 sends a final response back to the first institution 602 along with a KYC snapshot and updates the KYC data of the user over the blockchain or distributed ledger in case of any change or requirement of updating the KYC data of the user.

It would be appreciated by the person skilled in the art that the system offers a full-circle, adaptable, and intelligent solution for sharing KYC data to multiple authorized parties on a blockchain.

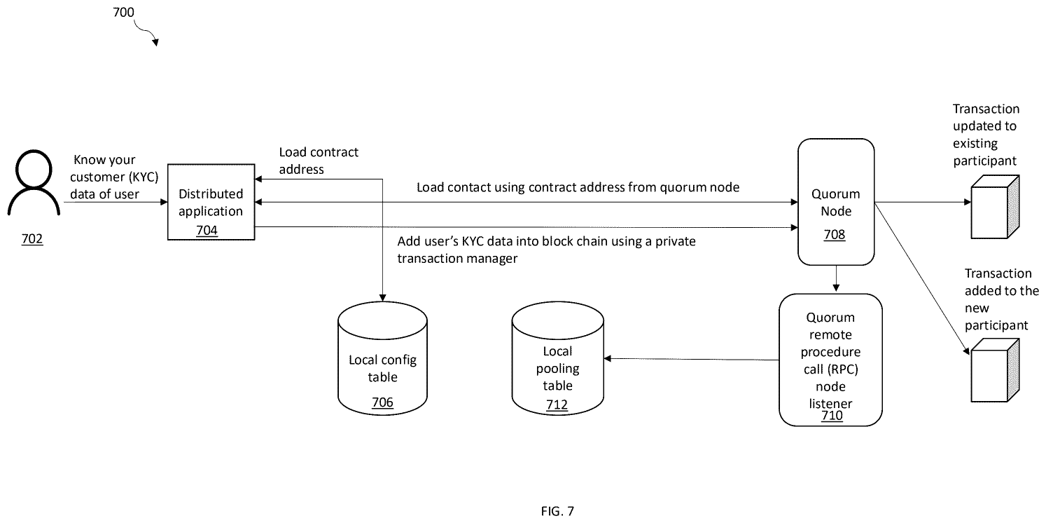

FIG. 7 illustrates an exemplary blockchain architecture depicting the loading of KYC details onto a blockchain, in accordance with an embodiment of the present disclosure. As illustrated in FIG. 7, the system flow 700 begins with receiving user identity details over a user interface (UI) (for example, banking product's user interface) for validating the user identity details and registering at least one know your customer (KYC) data upon completion of successful validation of the user identity details.

When a new client or user seeks onboarding, the participating bank (acting as a validator) searches a quorum network ledger (e.g., a private blockchain) for existing entries related to that client or user 702. Further, the at least one KYC data gets uploaded to an application 704 (e.g., distributed application or also referred to as “DApp”). The application 704 is associated with a first institution (such as a primary bank) that provides a service to the user 702. The distributed application 704 further creates a smart contract and loads the contract address into a local config table 706. The contract address may be associated with the at least one KYC data of the user. Further, the application is configured to load the smart contract using the contract address from a quorum node 708. Further, the quorum node 708 is provided by the quorum network ledger. The application is configured to add the at least one KYC data into a blockchain using a private transaction manager (such as Tessera®). The quorum node 708 may be configured to update a transaction for an existing participant. Further, the quorum node 708 may be configured to add a new transaction for a new participant. The quorum node 708 is further connected with a quorum remote procedure call (RPC) node listener 710. The quorum RPC node listener is a component within the blockchain network that continuously monitors incoming remote procedure calls. These remote procedure calls are requests for data, transactions, or interactions with smart contracts on the blockchain network. The quorum node 708 ensures that the RPCs are received, processed, and appropriately managed to facilitate seamless communication and transaction management within the blockchain network. Additionally, the quorum RPC node continuously monitors and manages blockchain transactions, updating a local pooling table 712 in real-time to ensure accurate and synchronized data handling within the blockchain network.

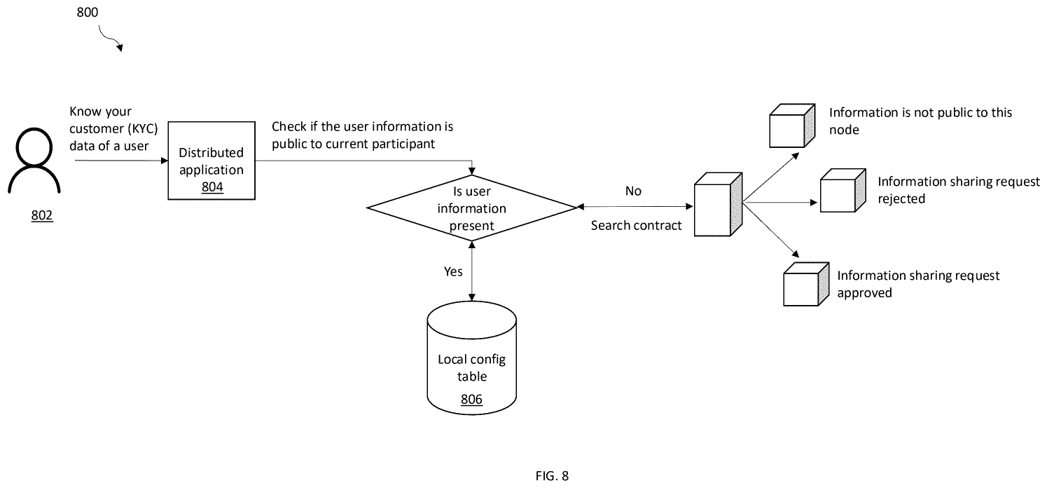

FIG. 8 illustrates an exemplary blockchain architecture depicting the process of accessing KYC details on a blockchain. As illustrated in FIG. 8, the system flow 800 begins with a second request to retrieve user KYC details over a user interface (UI) for validating the user 802. The user interface of a distributed application 804 is used to search for and access the at least one KYC data associated with the user. Thus, the distributed application is used to check if the user information is public to the current participant who is looking for the KYC details of the user. If the user information is present in the local configuration table 806, the current participant may directly access the KYC data from the local configuration table and perform the required action. If the KYC data is not available in the local configuration table, the participant may search for any contract available on the blockchain network via a quorum node to access the user KYC data. In an exemplary implementation, the current participant may not be able to access the information if the KYC data is not available on the blockchain network. In another exemplary implementation, the current participant may not be able to access the KYC data if the second request to access the information is rejected due to a failure in validation. In yet another exemplary implementation, the current participant may access the KYC data if the requested information of the user is available on the blockchain network, and the second request is approved after successful validation.

In general, initially, a miner (e.g., an entity) performs a KYC transaction and sends the payload of the KYC transaction to a blockchain network using a quorum node (installed on a physical server) to enclose a transaction with a smart contract object. The smart contract object may include a contract address, miner information, miner account information, and other details. Once the payload is enclosed, it is shared as a private transaction over the quorum node. A Merkle tree (an n-ary tree structure) contains the hashes of blocks, which helps maintain consensus among the nodes to verify the blocks and authenticate the participant to access the KYC data within the blockchain.

Advantages of the present disclosure are mentioned as follows: The present disclosure provides a promising solution for leveraging a blockchain technology to strengthen know your customer (KYC) processes and combat fraud using encryption techniques (for e.g., Tessera® and quorum). The present disclosure uses an encryption technique on a private blockchain to verify the identity of bank customers without revealing any identity information or details. The present disclosure also facilitates monetization of the KYC using blockchain by various means, namely storage optimization on each node of the blockchain using lazy loading and performance optimization. The present disclosure may also be used to offer value-added services like KYC data analytics and risk assessments. The present disclosure helps in cutting costs for organizations or banks by reducing manual tasks such as aggregating and amending data related to the KYC process. It creates efficiency in processing transactions. It also reduces manual tasks such as aggregating and amending data, as well as easing reporting and auditing processes.

The present disclosure helps to speed up the process of financial transactions by eliminating intermediaries, as well as replacing remaining manual KYC processes in transactions. In the present disclosure, the blockchain may be used to track information over time, enabling a secure, reliable audit of information. The present disclosure ensures strong fraud protection by combining the power of decentralized identity management, network analysis, smart contracts, and decentralized autonomous organizations (DAOs), the present innovation aims to create a more secure, efficient, and transparent KYC ecosystem.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated via a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions for sharing know your customer (KYC) data using a blockchain is disclosed. The instructions include executable code which, when executed by a processor 104, may cause the processor 104 to receive a first request from a user to access at least one service of a first institution; obtain user identity details from the user in response to the first request; register at least one KYC data for the user upon completion of a successful verification of the user identity details; store the at least one KYC data into at least one database associated with the first institution; load the at least one KYC data onto a distributed ledger through a smart contract, wherein the at least one KYC data is accessible with a private key associated with the at least one KYC data; receive a second request to access the at least one KYC data of the user on the distributed ledger, from a second institution; and provide access to the at least one KYC data to the second institution based on an execution of the smart contract using a successful verification of the private key.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

We claim:

1. A method for sharing a know your customer (KYC) data using a blockchain, the method being implemented by at least one processor, the method comprising:
receiving, by the at least one processor, a first request from a user to access at least one service of a first institution;
obtaining, by the at least one processor, user identity details from the user in response to the first request;
registering, by the at least one processor, at least one KYC data for the user upon a successful verification of the user identity details;
storing, by the at least one processor, the at least one KYC data into at least one database associated with the first institution;
loading, by the at least one processor, the at least one KYC data onto a distributed ledger through a smart contract, wherein the at least one KYC data is accessible with a private key associated with the at least one KYC data;
receiving, by the at least one processor, a second request to access the at least one KYC data of the user on the distributed ledger, from a second institution; and
providing, by the at least one processor, access to the at least one KYC data to the second institution based on an execution of the smart contract using a successful verification of the private key.

2. The method as claimed in claim 1, wherein the user identity details comprise personal identity details, contact details, income details, and transaction details.

3. The method as claimed in claim 1, wherein the at least one KYC data comprises verified documents corresponding to the user identity details.

4. The method as claimed in claim 1, wherein the smart contract comprises at least one from among a block identifier, a transaction identifier, a chain identifier, a contract address and business logic parameters.

5. The method as claimed in claim 1, wherein the smart contract is encrypted using encryption techniques to avoid an unauthorized access to the at least one KYC data.

6. The method as claimed in claim 1, wherein upon a successful completion of a blockchain consensus process, the at least one KYC data is loaded onto the distributed ledger.

7. The method as claimed in claim 6, wherein the successful completion of the blockchain consensus process further comprises:
validating, by the at least one processor, the smart contract by executing the blockchain consensus process involving a plurality of trusted parties associated with a blockchain network.

8. The method as claimed in claim 1, wherein the method further comprises:
updating, by the at least one processor, the at least one KYC data upon receipt of a data updating request from the second institution.

9. A computing device configured to implement an execution of a method for sharing a know your customer (KYC) data using a blockchain, the computing device comprising:
a processor;
a memory; and
a communication interface coupled to each of the processor and the memory, wherein the processor is configured to:
receive a first request from a user to access at least one service of a first institution;
obtain user identity details from the user in response to the first request;
register at least one KYC data for the user upon a successful verification of the user identity details;
store the at least one KYC data into at least one database associated with the first institution;
load the at least one KYC data onto a distributed ledger through a smart contract, wherein the at least one KYC data is accessible with a private key associated with the at least one KYC data;
receive a second request to access the at least one KYC data of the user on the distributed ledger, from a second institution; and
provide access to the at least one KYC data to the second institution based on an execution of the smart contract using a successful verification of the private key.

10. The computing device as claimed in claim 9, wherein the user identity details comprise personal identity details, contact details, income details, and transaction details.

11. The computing device as claimed in claim 9, wherein the at least one KYC data comprises verified documents corresponding to the user identity details.

12. The computing device as claimed in claim 9, wherein the smart contract comprises at least one from among a block identifier, a transaction identifier, a chain identifier, a contract address and business logic parameters.

13. The computing device as claimed in claim 9, wherein the smart contract is encrypted using encryption techniques to avoid an unauthorized access to the at least one KYC data.

14. The computing device as claimed in claim 9, wherein upon a successful completion of a blockchain consensus process, the at least one KYC data is loaded onto the distributed ledger.

15. The computing device as claimed in claim 14, wherein for the successful completion of the blockchain consensus process, the processor is further configured to:
validate the smart contract through execution of the blockchain consensus process involving a plurality of trusted parties associated with a blockchain network.

16. The computing device as claimed in claim 9, wherein the processor is further configured to:
update the at least one KYC data upon reception of a data updating request from the second institution.

17. A non-transitory computer readable storage medium storing instructions for sharing a know your customer (KYC) data using a blockchain, the storage medium comprising executable code which, when executed by a processor, causes the processor to:
receive a first request from a user to access at least one service of a first institution;
obtain user identity details from the user in response to the first request;
register at least one KYC data for the user upon a successful verification of the user identity details;
store the at least one KYC data into at least one database associated with the first institution;
load the at least one KYC data onto a distributed ledger through a smart contract, wherein the at least one KYC data is accessible with a private key associated with the at least one KYC data;
receive a second request to access the at least one KYC data of the user on the distributed ledger, from a second institution; and
provide access to the at least one KYC data to the second institution based on an execution of the smart contract using a successful verification of the private key.

18. The storage medium as claimed in claim 17, wherein the smart contract is encrypted using encryption techniques to avoid an unauthorized access to the at least one KYC data.

19. The storage medium as claimed in claim 17, wherein upon a successful completion of a blockchain consensus process, the at least one KYC data is loaded onto the distributed ledger.

20. The storage medium as claimed in claim 19, wherein for the successful completion of the blockchain consensus process, when executed by the processor, the executable code further causes the processor to: validate the smart contract through execution of the blockchain consensus process involving a plurality of trusted parties associated with a blockchain network.
